(19) United States
(12) Patent Application Publication
(10) Pub. No.: US 2026/0153754 A1
(43) Pub. Date: Jun. 4, 2026

(54) III-NITRIDE-BASED PHOTONIC DEVICES WITH QUANTUM CONFINEMENT

(71) Applicants: Mohammed Soltani, Ann Arbor, MI (US); The Regents of the University of Michigan, Ann Arbor, MI (US)

(72) Inventors: Walter Shin, Ann Arbor, MI (US); Ping Wang, Ann Arbor, MI (US); Zetian Mi, Ann Arbor, MI (US); Mohammed Soltani, Cambridge, MA (US)

(21) Appl. No.: 19/122,938

(22) PCT Filed: Oct. 20, 2023
(86) PCT No.: PCT/US2023/077451

§ 371 Date: Apr. 21, 2025

Related U.S. Application Data
(60) Provisional application No. 63/417,838, filed on Oct. 20, 2022.

(51) Int. Cl. G02F 1/017; G02F 1/015

(52) U.S. Cl. CPC G02F 1/01716; G02F 1/0154; G02F 2202/108

(57) ABSTRACT

A photonic device includes a substrate and a heterostructure supported by the substrate. The heterostructure includes a base layer comprising an aluminum nitride (AlN)-based material, and a multiple quantum well or short-period superlattice structure supported by the base layer. The multiple quantum well or short-period superlattice structure includes a stack of AlN-based quantum well layers and AlN-based barrier layers.

### CROSS-REFERENCE TO RELATED APPLICATION

This application claims the benefit of U.S. provisional application entitled “III-Nitride-Based Photonic Devices with Quantum Confinement,” filed Oct. 20, 2022, and assigned Ser. No. 63/417,838, the entire disclosure of which is hereby expressly incorporated by reference.

### BACKGROUND OF THE DISCLOSURE

### Field of the Disclosure

The disclosure relates generally to photonic devices.

### Brief Description of Related Technology

Photonic integrated circuits (PICs) based on III-Nitride (III-N) materials, which includes AₓlGa₁₋ₓN, are an emerging technology platform with a wide range of optical transparency from ultraviolet (UV) to mid-infrared (IR) wavelengths. This platform enables active and passive PIC components with high power handling properties and second- and third-order nonlinear optical properties. These features allow a variety of linear and nonlinear PIC devices operating over a broad range of wavelengths. In the III-N family, Aluminum Nitride (AlN) PIC devices have been extensively pursued with demonstrated works on high-Q resonators, electro-optic (EO) modulators, on-chip frequency comb, and second/third harmonics generation.

Despite the attractive characteristics of AlN, its Pockels EO coefficient, related to second-order susceptibility, is weak and limited to r₁₃ and r₃₃ around 1 pm/V. FIG. 1 shows the EO coefficients of some photonic materials and their operational wavelength window. Though materials such as LiNbO₃ have a strong Pockels effect, it is subjected to photorefractive damage at shorter wavelengths and higher optical powers. Therefore, use of such materials at shorter wavelengths (UV/vis/near IR) is problematic.

Several efforts have been made to increase the EO effect in III-N semiconductors. Although many approaches, such as quantum confined stark effect (QCSE), have been very promising, such approaches have limited the operation near the bandgap of the quantum well. Another method employed the third-order susceptibility of III-N semiconductors and applied an external DC electric field along the optical axis to generate an electric-field induced second-order effect. A more recent work utilized a high internal polarization field based on GaN/AlGaN superlattices to produce a ten times higher Pockels coefficient than bare GaN, as shown in FIG. 1, and provided additional freedom for manipulating the EO effect. The Pockels coefficient of the GaN/AlGaN multiple quantum wells was competitive with LiNbO₃ and offered even higher values near the band edge due to the resonance effect. However, most studies are limited to GaN film, with no demonstration of the effect in an integrated photonic platform suitable from UV and visible wavelengths to IR wavelengths.

### SUMMARY OF THE DISCLOSURE

In accordance with one aspect of the disclosure, a photonic device includes a substrate and a heterostructure supported by the substrate. The heterostructure includes a base layer including an aluminum nitride (AlN)-based material and a multiple quantum well or short-period superlattice structure supported by the base layer. The multiple quantum well or short-period superlattice structure includes a stack of AlN-based quantum well layers and AlN-based barrier layers.

In accordance with another aspect of the disclosure, a photonic device includes a substrate and a heterostructure supported by the substrate. The heterostructure includes a base layer including a III-nitride material having a bandgap greater than about 4 eV and a multiple quantum well or short-period superlattice structure supported by the base layer. The multiple quantum well or short-period superlattice structure includes a stack of alternating III-nitride quantum well layers and III-nitride barrier layers.

In accordance with yet another aspect of the disclosure, a photonic device includes a substrate and a heterostructure supported by the substrate. The heterostructure includes a base layer including a III-nitride material and a multiple quantum well or short-period superlattice structure supported by the base layer. The multiple quantum well or short-period superlattice structure includes a stack of alternating III-nitride quantum well layers and III-nitride barrier layers. The III-nitride material of the base layer and the III-nitride quantum well layers are lattice mismatched.

In connection with any one of the aforementioned aspects, the devices described herein may alternatively or additionally include or involve any combination of one or more of the following aspects or features. The AlN-based quantum well layers include AlGaN. The AlN-based barrier layers include AlN. The heterostructure further includes a buffer layer disposed between the base layer and the stack of AlN-based quantum well layers and AlN-based barrier layers. The buffer layer includes AlN. The photonic device further includes an electrode spaced from the heterostructure to apply an electric field to the heterostructure. The photonic device further includes a waveguide bus disposed alongside the heterostructure for photonic coupling with the heterostructure. The heterostructure is a ring-shaped. The AlN-based material of the base layer is AlN. The AlN-based quantum well layers have an Al composition that falls in a range from about 75% to about 80%. The substrate includes sapphire. The III-nitride quantum well layers include AlGaN. The III-nitride barrier layers include AlN. The III-nitride quantum well layers have an Al composition that falls in a range from about 75% to about 80%. The base layer includes AlN. The heterostructure further includes a buffer layer disposed between the base layer and the stack of alternating III-nitride quantum well layers and III-nitride barrier layers. The buffer layer includes AlN.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts a graphical plot of reported Pockels coefficient (r₁₃ and r₃₃) values and their cutoff wavelength for the following materials: LiNbO₃, GaN, GaN/AlGaN multiple quantum wells (MQWs), and AlN, in comparison with a heterostructure in accordance with one example, in which error bars show the Pockels coefficient variation within wavelength.

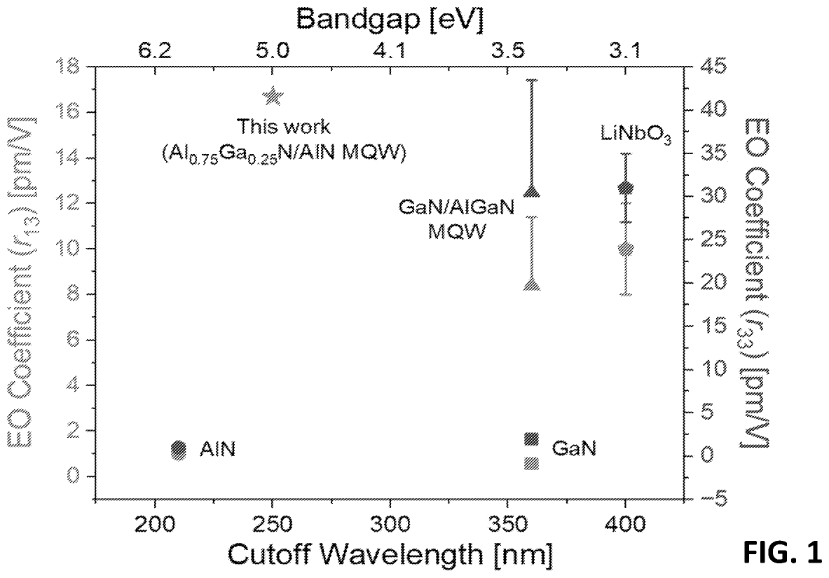

FIG. 2 depicts (a) a schematic illustration of regrown AlGaN/AlN MQWs on AlN-on-sapphire in accordance with one example, as well as graphical plots of (b) high-resolution XRD patterns of 2θ/omega scan for examples with MQWs and without MQWs along the (0002) direction (the satellite diffraction peaks can be observed from the MQW sample, which indicate a good periodicity of MQWs), (c) photoluminescence spectra of three regrown examples, and (d) the simulated band structure of regrown AlGaN/AlN MQWs on AlN (the inset shows the built-in field in the quantum well and barrier layers due to spontaneous and piezoelectric polarization).

FIG. 3 depicts (a, b) schematic illustrations of microring resonator modulators (MRMs) and a magnified ring resonator in accordance with one example, as well as (c, d) cross-sections of example MRMs for operation at telecom wavelengths (examples A and B) and at about 780 nm (example C), respectively (thin Al₂O₃ is included in example C to increase the coupling efficiency), and (e, f) graphical plots of the simulated electric field E_{z} of each layer, along the dashed lines shown in the illustrations in parts (c) and (d), respectively.

FIG. 4 depicts SEM images of (a) example microring resonators labeled sample A (left), C (middle), and representative sidewall (right), and (b) optical microscope images of the example MRMs on samples A and C.

FIG. 5 depicts (a) a normalized transmission spectrum for a microring resonator made in accordance with example A (see Table 1 for the specifications), (b) a magnified transmission spectrum near 1554 nm, in which λ_{3dB} shows the input wavelength used for frequency response measurement, (c) resonance wavelength shifts as a function of applied voltage of MRMs on Sample A (blue) and bare AlN with SiO₂ cladding (dashed black), with the inset showing the simulated mode profile of the ring resonator on Sample A, (d) calculated effective refractive index variation of MRMs on Sample A (blue), bare AlN with SiO₂ cladding (dashed black), and bare AlN with Al₂O₃ cladding (dashed red) as a function of applied electric field (E_{z}), in which bare AlN MRM with Al₂O₃ cladding (dashed red) shows a negative relationship between applied electric field and effective index variation.

FIG. 6 depicts measured (dots) and averaged (solid line) frequency response of EO modulation at telecom wavelength (Sample A) with a 3 dB bandwidth of 27 GHz (the laser wavelength is parked at the full-width half-maximum of the resonator).

FIG. 7 depicts graphical plots of (a) a normalized transmission spectrum for a microring resonator made in accordance with example C (see Table 1 for the specifications), (b) a magnified transmission spectrum near 768.7 nm, (c) resonance wavelength shifts as a function of the applied voltage of MRMs for example C (undashed) and bare AlN (dashed), in which the inset shows the simulated mode profile of ring resonator in accordance with example C, and d) calculated effective refractive index variation of MRMs in accordance with example C (undashed) and bare AlN (dashed) as a function of applied electric field (E_{z}).

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAlLED DESCRIPTION OF THE DISCLOSURE

Photonic devices having an AlN-based heterostructure are described. The disclosed devices may include a heterostructure configured to define multiple quantum wells or short-period superlattices on an AlN-based template or base. For instance, the heterostructure may include AlGaN/AlN-based quantum wells. In some cases, the heterostructures of the disclosed devices are configured as a microring resonator modulator. The quantum confinement provided by the heterostructures of the disclosed devices achieves an enhanced Pockels effect.

The AlN-based heterostructures of the disclosed devices are useful in a number of ways. For instance, the AlN-based layers combine low loss operation in a wide range of wavelengths with much stronger polarization fields. Lattice mismatch between the AlN-based materials increases the quantum confinement provided by the heterostructures. These and/or other features of the heterostructures of the disclosed devices support the enhancement of linear and non-linear optical properties, e.g., by a factor of about 10 or more, as explained herein. The use of AlN-based materials may also facilitate integration with other devices (e.g., to provide optoelectronic systems) and fabrication technologies.

Examples of the disclosed devices provide an enhanced Pockels effect in an AlN-integrated photonic platform by employing high Al composition AlGaN/AlN MQW heterostructures regrown on top of an AlN layer on a sapphire substrate. This enhancement is based on the high second-order susceptibility of the MQW layer which can be attributed to the electric-field induced second-order effect with its large built-in polarization field. For the enhancement characterization, examples of microring modulators (MRMs) with MQW layers were used to measure the resonance shift versus the applied voltage. By comparing AlN MRMs with similar dimensions but without MQWs, resonance shift enhancements of 2.16 times and 1.56 times at 1550 nm and 780 nm wavelengths, respectively, were attained. The extracted second-order susceptibilities of AlGaN/AlN MQWs show an order of magnitude higher than AlN. The 3 dB bandwidth of the example MRMs with the MQW layer were also measured, and exhibited a 27 GHz bandwidth for the 1550 nm wavelength modulator.

Although described in connection with heterostructures having layers composed of, or otherwise including, AlGaN and AlN, the composition and/or other characteristics of the heterostructures of the disclosed devices may vary. Other AlN-based and III-nitride materials may be used. For instance, the quantum well layers of the heterostructures may be composed of, or otherwise include, ScAlN, InGaN, and GaN. The barrier layers may be composed of, or otherwise include, III-nitride materials other than AlN. The composition of the waveguides of the disclosed devices may also vary from the examples described herein. For instance, other AlN-based materials may be used, including, for instance, ScAlN.

Although described in connection with microring resonator modulators, the disclosed heterostructures and devices may be incorporated into to a wide variety of photonic devices. For instance, the heterostructures may be configured as, or otherwise include, non-ring shaped resonator structures, such as photonic crystal structures. The disclosed heterostructures and devices may also be configured for photonic functions other than modulation.

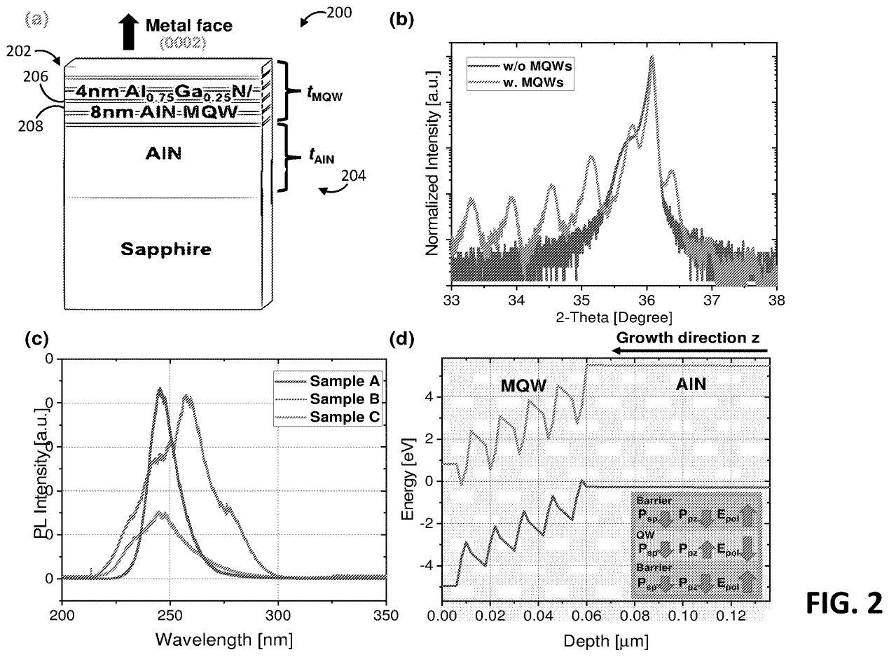

FIG. 2, part a, shows a schematic illustration of a photonic device 200 having metal-face AlGaN/AlN MQWs 202 regrown on an AlN-on-sapphire template 204. The photonic device 200 may be configured as an MRM device. Quantum well layers 206 and barrier layers 208 of the MQWs 202 may be grown using a Veeco GENxplor MBE system equipped with a radio frequency plasma-assisted nitrogen source and Knudsen effusion cells for Ga and Al sources. In this example, AlN is etched down to about 400 nm and, subsequently, a 100 nm AlN buffer layer and AlGaN/AlN MQWs are grown on top. To investigate the effect of MQWs at different wavelengths, devices with five MQWs (referred to herein as examples or samples A and C) and three MQWs (referred to herein as example or sample B) were grown with similar growth conditions. In these examples, the thickness of each quantum well layer and barrier layer are 4 nm and 8 nm, and the total thickness of all waveguides is about 550 nm. The respective thicknesses of the quantum well and barrier layers may vary in other cases.

The EO effects of examples A and B were measured at a telecom wavelength (1550 nm) regime, whereas example C was measured at about 780 nm. The characteristics of each example are listed in Table 1 below. A higher Pockels coefficient enhancement is expected when using a lower Al composition (i.e., smaller x) in the AlₓGa₁₋ₓN/AlN MQWs, as it provides a higher internal polarization field. However, with low Al composition AlGaN/AlN MQWs, higher optical loss is expected due to the larger lattice mismatch from dislocation and defects, which presents a fundamental trade-off. In addition, the propagation loss of the MRM device is sensitive to material quality and thickness of regrown layers, which are, in turn, affected by the etched AlN template and growth conditions. Thus, the MQW layers were optimized or otherwise configured to provide a high internal polarization field and moderate propagation loss for the waveguide and the resonator device.

FIG. 2, part b, shows the results of high-resolution X-ray diffraction (XRD) 2theta-omega scans of (0002) plane for (i) an example with regrown AlGaN/AlN MQWs (with MQWs) and (ii) an AlGaN epilayer (without MQWs) on AlN templates. The same growth conditions were used to obtain an Al composition of AlGaN quantum wells in the range of 75-80%. Satellite diffraction peaks from the MQW examples confirm sharp interfaces between the quantum well and barrier layers.

FIG. 2, part c, shows the photoluminescence of the regrown examples measured using a 193 nm ArF excimer laser, where similar emission peaks are found around 250 nm. Examples B and C show shoulder peaks attributed to slightly different Al compositions at the interface of the quantum well and barrier layers.

FIG. 2, part d, shows the simulated band structure of an example AlGaN/AlN MQW structure. Due to the presence of large spontaneous and piezoelectric polarization, a high built-in electric field of about 2.4 to about 2.97 MV/cm is estimated along the optical axis of the structure. The calculated polarization field is high enough to observe the enhancement of the nonlinear optical signal. In addition, the inset of FIG. 2, part d, shows the direction of the polarization and the built-in internal field within each layer, with the built-in field in the quantum well layer pointing downwards to the substrate.

TABLE 1
Specifications of regrown MQWs on the AIN samples

| | Number of | | Wavelength of |
|---|---|---|---|
| Sample # | MQW layers | *t_{AIN} and t_{MQW} | experiment |
| A | 5 | t_{AIN}~500 nm | Telecom |
| | | t_{MQW}~60 nm | (1550 nm) |
| B | 3 | t_{AIN}~500 nm | Telecom |
| | | t_{MQW}~36 nm | (1550 nm) |
| C | 5 | t_{AIN}~500 nm | 780 nm |
| | | t_{MQW}~60 nm | |

*Estimated thickness of AIN (t_{AIN}) and MQWs(t_{MQW})

Microring Modulator Example. To measure the enhancement of the Pockels coefficient due to the MQW structure, examples of MRMs were fabricated to measure their resonance shift when applying a voltage. The results were compared with AlN MRMs of similar dimensions without MQWs. Utilizing a resonator makes the EO measurement easier as the light travels many roundtrips in the ring resonator.

The relationship between the effective refractive index of ring resonator variation (Δn_{eff}) and linear Pockels effect due to applied bias can be described by

$$Δ {n}_{eff} = \frac{{χ}_{eff}^{( 2 )} {En}_{g}}{2 {n}_{o}^{2}} \qquad ( 1 )$$

where

$${χ}_{eff}^{( 2 )}$$

represents the modal average effective second-order susceptibility, E is the external electric field, n_{g} is the group index, and n₀ is the material refractive index. In this case, the transverse electric (TE) mode of the resonator is focused on, where the ordinary refractive index is used as the material refractive index. For each sample, n₀ is measured with a spectroscopic ellipsometer and extracted by fitting it to a Cauchy dispersion.

The effective second-order susceptibility

$$( {χ}_{eff}^{( 2 )} ) ,$$

which is the overall effect on the guided mode along with the χ⁽²⁾ tensor distributed in the waveguide, can be defined as follows:

$${x}_{eff}^{( 2 )} = \frac{{\int }_{wg} {χ}_{mat}^{( 2 )} ( {x}_{t} ) {n}_{0}^{2} ( {x}_{t} ) {\vert {e}_{x} ( {x}_{t} ) \vert}^{2} {dx}_{t}}{{\int }_{∞} {n}_{0}^{2} ( {x}_{t} ) {\vert e ( {x}_{t} ) \vert}^{2} {dx}_{t}} \qquad ( 2 )$$

where e(xₜ) is the modal electric field profile, xₜ denotes the transverse coordinates with respect to the light propagation direction and

$${χ}_{mat}^{( 2 )} ( {x}_{t} )$$

represents the second-order susceptibility of materials distributed in the waveguide. Because

$${χ}_{eff}^{( 2 )}$$

is based on the overlap between the optical guided mode and the second-order susceptibility distributed in the waveguide, high

$${χ}_{eff}^{( 2 )}$$

is expected by including a high second-order susceptibility layer and increasing its overlap with the optical guided mode. In addition, it allows one to extract

$${χ}_{mat}^{( 2 )}$$

of each layer based on the measured

$${χ}_{eff}^{( 2 )}$$

and calculated optical guided mode distribution.

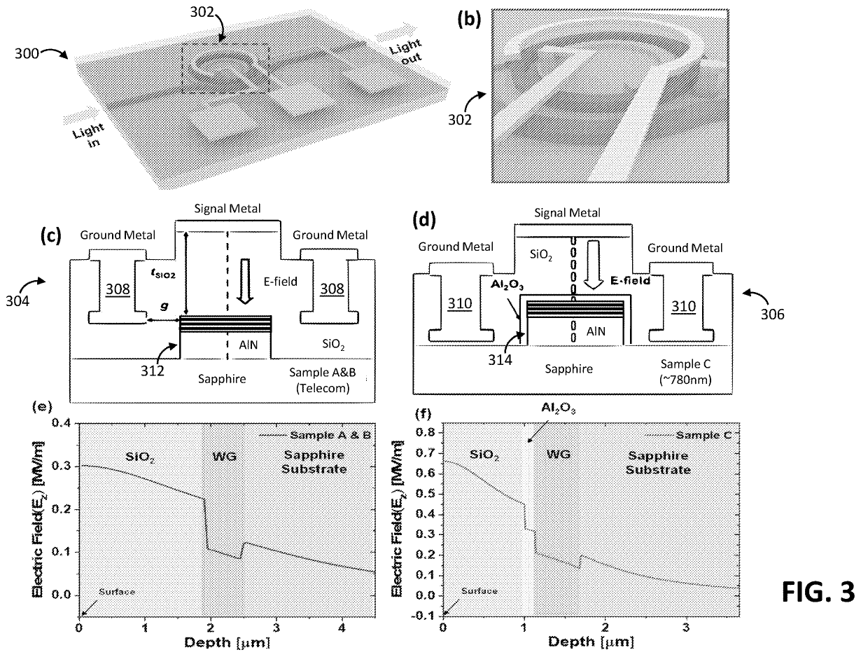

To utilize the highest EO effect, an out-of-plane DC electric field (E_{z}) is used because r₁₃ and r₃₃ show the highest EO coefficient for c-axis oriented AlN. FIG. 3, parts a and b, schematically show an MRM device 300 having a ring resonator 302 in accordance with one example. The ring resonator 302 includes a multiple quantum well or short-period superlattice structure as described herein. FIG. 3, parts c and d, show the cross-sections of example ring resonators 304, 306 for operation at, e.g., telecom wavelengths and 780 nm, respectively. Ground metal electrodes or structures 308, 310 are disposed on or along the lateral sides of a core of the ring resonators 304, 306, and a signal metal electrode or structure is placed on top of the ring resonator above the cores, which may be wider than a waveguide of the MRM device to provide a uniform electric field in the waveguide.

As described herein, each resonator core includes a heterostructure 312, 314 supported by a substrate (e.g., sapphire substrate). Each heterostructure 312, 314, in turn, includes a base layer and a multiple quantum well or short-period superlattice structure supported by the base layer. The base layer may be composed of, or otherwise include, an aluminum nitride (AlN)-based material. The multiple quantum well or short-period superlattice structure may include a stack of AlN-based quantum well layers and AlN-based barrier layers as described herein.

In some cases, the heterostructure of each resonator core further includes a buffer layer disposed between the base layer and the stack of AlN-based quantum well layers and AlN-based barrier layers. In the examples shown in FIG. 3, the buffer layer has the same composition as the base layer (e.g., AlN). The buffer and base layers may thus be depicted collectively, e.g., as an integrated structure.

The positions of the signal and ground metal structures may be optimized for maximizing the applied electric field in the resonator core and minimizing any optical absorption due to the proximity of these metals to the resonator. The dimensions of MRMs in accordance with examples A and B include a radius of 100 μm, ring resonator width of 3 μm, SiO₂ cladding thickness (t_{SiO2}) of 1.9 μm, and distance between the ground metal and the ring resonator (g) of 2 μm. For the MRM devices in accordance with example C, a radius of 30 μm and ring resonator width of 0.9 μm, t_{SiO2}=1 μm, and g=1.3 μm were used. To increase the coupling efficiency, a pulley coupling scheme is utilized, allowing a wider gap between the two waveguides. Accordingly, the gap between the ring resonator and the bus waveguide, and the width of the bus waveguide, are optimized or otherwise configured for enhanced waveguide-resonator coupling and their phase-matching condition.

The ring resonator 306 in accordance with example C for operation at about 780 nm wavelength further includes an Al₂O₃ layer to further increase the coupling efficiency between the ring resonator and the bus waveguide. In one example, the Al₂O₃ layer has a thickness of about 130 nm, but other thicknesses may be used.

Based on the MRM configurations at telecom wavelengths (FIG. 3, part c) and at about 780 nm (FIG. 3, part d), the out-of-plane electric field (E_{z}) of each layer was simulated by COMSOL. FIG. 3, parts e and f, show the calculated E_{z} at different layers following the dashed line, shown in FIG. 3, parts c and d, where the average E_{z} in the resonator have an E_{avg} of about 0.098 MV/m (Sample A and B), and an E_{avg} of about 0.18 MV/m (Sample C) under an applied voltage of 1V. Calculated E_{avg} can be used to extract the effective second-order susceptibility of the demonstrated MRM along with the measured refractive index variation. It is assumed that the effective refractive index variation only results from the out-of-plane electric field, where the in-plane EO coefficient (r₅₁) is an order of magnitude lower.

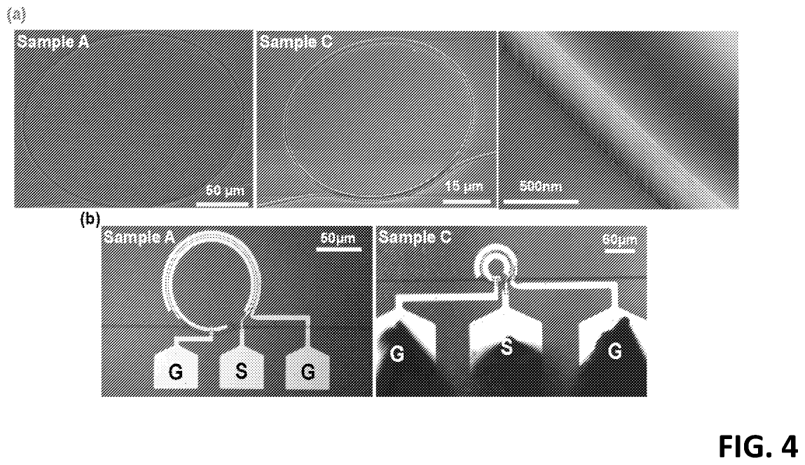

Further details regarding the process of fabricating the portions of the MRM devices outside of the resonator core can be found in Shin, W. et al., “Demonstration of green and UV wavelength high Q aluminum nitride on sapphire microring resonators integrated with microheaters,” Appl Phys Lett 2021, 118 (21), 211103, the entire disclosure of which is hereby incorporated by reference. In brief, after defining the AlN-based microring resonator, buffered HF is used to remove the two layers of the hard mask, SiO₂ and Al₂O₃, where FIG. 4, part a, shows the SEM images of the defined ring resonators and representative sidewalls. The bottom part of the waveguide shows a somewhat rougher sidewall compared to the upper side. This is not from the etching process, but mainly due to the growth method of the commercial AlN template. For Samples A and B, 500 nm SiO₂ is deposited, e.g., with plasma-enhanced chemical vapor deposition (PECVD), whereas, for Sample C, 130 nm Al₂O₃ is deposited, e.g., with atomic layer deposition (ALD). Then Ti(10 nm)/Au(140 nm)/Al (50 nm) layers are directly deposited on the lateral sides of the AlN ring resonator as the ground metal structures, followed by 1.4 μm (Samples A and B) and 1 μm PECVD SiO₂ (Sample C) deposition as a cladding layer. The signal metal with Ti(15 nm)/Au(85 nm) metal stacks are sputtered on top of SiO₂, underneath which the ring resonator is located. After making SiO₂ openings for via contacts, Ti/Al/Au metal stacks are evaporated as a metal via and the ground-signal-ground (GSG) contact pads. Finally, dicing and polishing to expose the waveguide facets are performed, with microscope images shown in FIG. 4, part b.

To characterize the operation of the example resonators and their EO effect, laser light from a tunable laser source was coupled to the waveguide for propagation to the waveguide-resonator region. The transmitted light after the waveguide-resonator interaction was collected from the other end of the waveguide. The resonance spectrum was measured by sweeping the laser wavelength and monitoring the transmission. The TE mode of the resonator was used, which shows lower propagation loss and is useful in measuring the resonance wavelength shift.

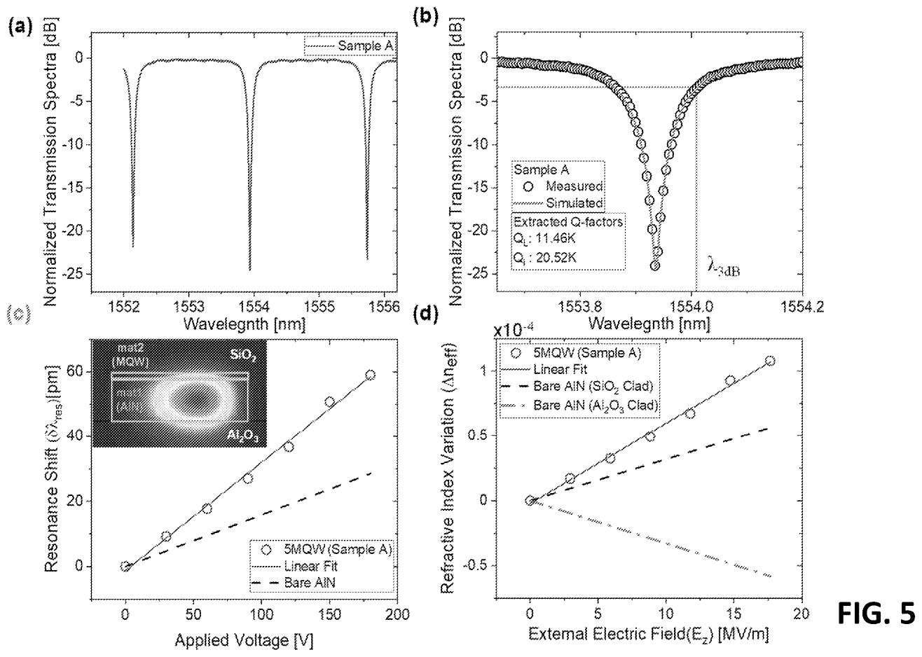

FIG. 5, part a, shows the TE mode transmission spectrum of Sample A. From this spectrum, a free spectral range (FSR) of 1.8 nm was measured, and based on the given relationship, FSR=λ²/(n_{g}L) with L the round-trip length, the corresponding group index of 2.14 was extracted.

FIG. 5, part b, shows the magnified transmission spectrum around 1553.9 nm with an extracted loaded quality factor (Q_{L}) of 11,460 and an extinction ratio of 25 dB, which shows a near critical coupling condition. The intrinsic Q (Qᵢₙₜ) of MRM on Sample A showed about 20K (propagation loss: 18.3 dB/cm), which is significantly lower than the Qᵢₙₜ of bare AlN MRM without MQWs which is ˜800K (propagation loss: 0.47 dB/cm). Considering that the fabrication process and the geometry of the example resonator devices are the same, the high propagation loss can be attributed to the MQW regrown layers. Because the commercial AlN was thinned down with plasma etching before buffer AlN and MQW regrowth, significant surface damage and defects are expected that result in the poor material quality of the regrown layers. Another factor is the scattering loss at the interfaces between the quantum well and barrier layers where a high density of defect/dislocation is expected due to lattice mismatch. This is also confirmed with the additional investigation of MRMs with 10 MQWs and 15 MQWs, which exhibited much degraded Qᵢₙₜ.

A positive external bias was applied to the signal metal to observe the EO effect, where E_{z} and the built-in polarization field are in the same direction. As shown in FIG. 5, part c, MRM example A (undashed) and AlN MRM without MQWs (dashed) follow a linear relationship between the applied bias and resonance wavelength shift. Based on the following equation, the corresponding effective refractive index variation can be extracted.

$$Δ {λ}_{r e s} = {λ}_{r e s} \frac{Δ {n}_{eff} η}{{n}_{g}} \qquad ( 3 )$$

where Δλᵣₑₛ represents resonance wavelength variation, and η is the fraction of the resonator perimeter where the index change occurs. In our design, η is 0.75 for all the samples. FIG. 5(d) shows the effective refractive index variation as a function of the applied electric field, where E_{z} of 0.098 MV/m at 1V, simulated by COMSOL, is assumed in the resonator.

Based on Equations (1) and (3), MRM example A (5 MQWs) exhibited 2.16 times higher

$${χ}_{eff}^{( 2 )}$$

compared to bare AlN (without MQWs), which can be attributed to the large Pockels coefficient of the AlGaN/AlN MQWs. The huge internal polarization field can induce the third-order nonlinear effect and increase the effective nonlinearity in the AlGaN/AlN MQW structure. Similar enhancement is found for MRMs in accordance with example B. All parameter values for extracting

$${χ}_{eff}^{( 2 )}$$

of examples A, B, and bare AlN are listed in Table 2.

TABLE 2
Parameter values to extract χ⁽²⁾ of Sample A, B, and bare AIN at telecom
wavelength

| | | | AlN (SiO₂ |
|---|---|---|---|
| Structure | Sample A | Sample B | cladding) |
| ${χ}_{eff}^{( 2 )} ( pm / V )$ | 25.36 | 20.16 | 11.7 |
| n_{g} | 2.14 | 2.17 | 2.17 |
| n₀ | 2.073 | 2.073 | 2.042 |
| Γ_{AlN} (%) | 71.13 | 70.86 | 75.3 |
| Γ_{MQW} (%) | 4.61 | 2.60 | — |
| ${χ}_{AlN}^{( 2 )} ( pm / V ) / {r}_{13} ( pm / V )$ | 15.6/0.89 | 15.6/0.89 | 15.6/0.89 |
| ${χ}_{MQW}^{( 2 )} ( pm / V ) / {r}_{13} ( pm / V )$ | 308.97/16.7 | 349.44/18.9 | — |

To extract the second-order susceptibility of the MQW structure, constant second-order susceptibilities of AlN and MQWs in the waveguide are assumed, and Equation (2) can be simplified with the mode confinement factor (Γ), a fraction of optical power in each waveguide layer, as follows:

$${χ}_{eff}^{( 2 )} = {χ}_{mat 1}^{( 2 )} {Γ}_{mat 1} + {χ}_{mat 2}^{( 2 )} {Γ}_{mat 2} \qquad ( 4 )$$

where mat1 is AlN and mat2 is MQW for the regrown samples. The mode confinement factor for each sample was calculated by Lumerical MODE solution, where the inset of FIG. 5, part c, shows the optical mode profile of Sample A.

First, from the bare AlN MRM resonance shift measurement,

$${χ}_{A l N}^{( 2 )}$$

(about 15.6 μm/N) was calculated based on the measured

$${χ}_{eff}^{( 2 )}$$

(about 11.7 pm/V) and the simulated mode confinement factor (Γ_{AlN} of about 75%). With the knowledge of extracted

$${χ}_{A l N}^{( 2 )}$$

and the simulated mode confinement factor of each layer of the regrown samples,

$${χ}_{M Q W}^{( 2 )}$$

of Sample A and B can be extracted. Calculated

$${χ}_{MQW}^{( 2 )}$$

of Samples A and B were 308.97 pm/V and 349.44 pm/V, respectively, which are 19.8 and 22.4 times higher than

$${χ}_{AlN}^{( 2 )} .$$

With a relationship given by

$${r}_{i j k} = {χ}_{ijk}^{( 2 )} / {n}_{0}^{4} ,$$

the corresponding Pockels coefficients are calculated as 16.7 pm/V (Sample A), 18.9 pm/V (Sample B) and 0.89 pm/V (bare AlN). The extracted Pockels coefficient of bare AlN is similar to previously reported values, which validates our measurement and analysis. All the parameter values used for extracting χ⁽²⁾ of Sample A, B, and bare AlN are listed in Table 2.

The effect of different dielectric cladding layers, SiO₂ and Al₂O₃, on the second-order susceptibility of bare AlN MRM at telecom wavelength was also investigated. Two different AlN MRMs are demonstrated where, for one sample, the SiO₂ cladding layer is deposited directly on the AlN waveguide, shown in FIG. 3, part c. In contrast, 130 nm Al₂O₃ is included between the AlN waveguide and SiO₂ cladding layer for the other sample. Except for the thin Al₂O₃ cladding layer, other geometries and features may be identical. As shown in FIG. 5, part d, a similar magnitude of effective second-order susceptibilities with the different signs of Pockels coefficient was observed. This can be due to the different polarity of fixed charges at the AlN-dielectric cladding interface.

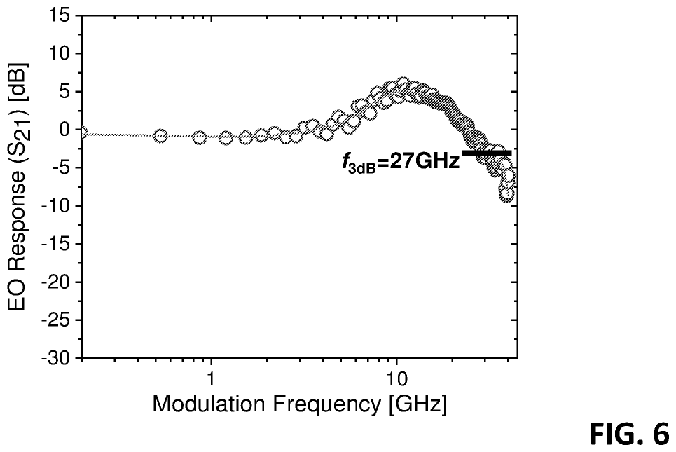

Furthermore, the frequency response of the EO resonator modulator was investigated. Using a 40 GHz network analyzer, the EO modulation amplitude in the frequency domain (S₂₁) of Sample A was measured. The result is shown in FIG. 6, where the 3 dB cutoff frequency is near 27 GHz. This cutoff frequency is limited by the cavity photon lifetime. The optical modulation dynamics of MRM can be represented by solving the coupled-mode theory, which typically shows the characteristics of a second-order system having two poles one zero represented as follows:

$$Δ ( s ) = G \frac{s + z}{{s}^{2} + ( 2 / τ ) s + {D}^{2} + 1 / {τ}^{2}} \qquad ( 5 )$$

where τ is the electric field amplitude decay time constant with 1/τ=1/τₑ+1/τᵢ. τᵢ and τₑ are amplitude decay time constants due to the intrinsic loss inside the ring resonator and the ring to bus waveguide coupling, respectively. The parameter z represents zero of pole/zero systems and the parameter D is detuning which shows the difference between the input frequency and resonance frequency of the ring resonator (=ωᵢₙ−ωᵣₑₛ). The example MRM shows the response peak around 10 GHz, which results from the constructive interference between light inside the modulator and the input light from the bus waveguide with the beating frequency of detuning.

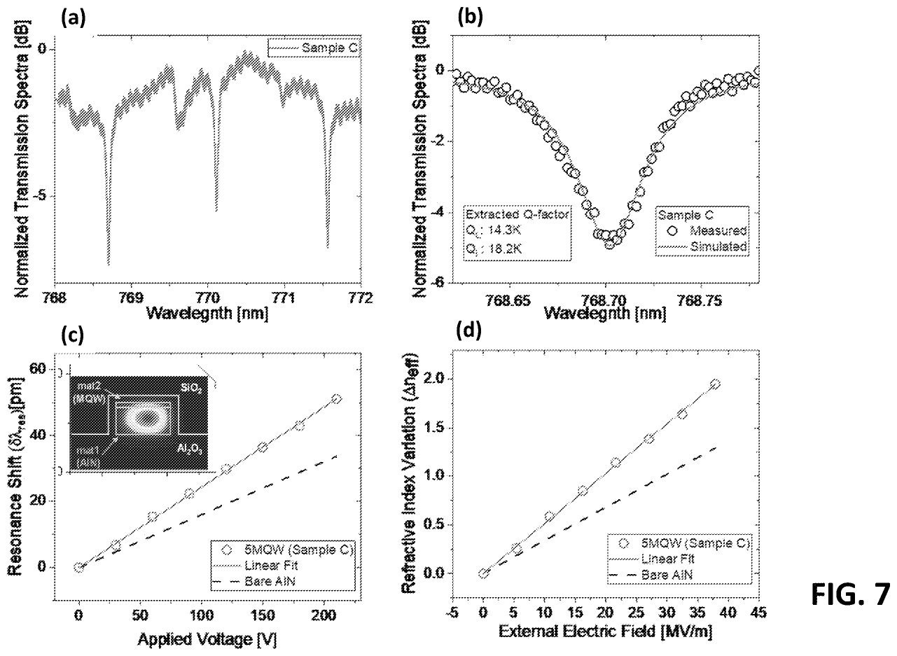

Similar investigations were done at a wavelength of 780 nm with Sample C and bare AlN (without MQWs) with the similar structure shown in FIG. 3, part d. Due to the thin Al₂O₃ layer, a negative relationship between the external electric field and the effective refractive index variation was observed. FIG. 7, part a, shows the TE mode transmission spectrum of Sample C. An FSR of 1.43 nm was measured from the spectrum and the corresponding group index of 2.2 was extracted. FIG. 7, part b, shows the magnified transmission spectrum around 768.7 nm with an extracted Q_{L} of 14,300. FIG. 7, parts c and d, show the resonance wavelength shift when applying a voltage and its corresponding effective refractive index variation as a function of the applied electrical field (E_{z}). As shown in FIG. 3, part f, it is assumed that E_{z} is about 0.18 MV/m at 1V in the waveguide, simulated by COMSOL. From Eq. (1) and (3), extracted

$${x}_{eff}^{( 2 )}$$

of Sample C is −20.4 pm/V, which is 1.56 times higher compared to

$${χ}_{eff}^{( 2 )}$$

of bare AlN (−13.0 pm/V). Calculated

$${χ}_{A l N}^{( 2 )}$$

from bare AlN MRM and

$${χ}_{M Q W}^{( 2 )}$$

from MRM of Sample C are −14.3 μm/V and −139.7 pm/V, respectively, where the MQWs show 9.76 times higher second-order susceptibility than bare AlN. The corresponding Pockels coefficients are −0.79 pm/V (bare AlN) and −7.3 pm/V (Sample C). All the values that are used for extraction are listed in Table 3.

TABLE 3
Parameter values to extract x(2) of Sample C and bare AIN at 780 nm
wavelength

| Structure | Sample C | AlN |
|---|---|---|
| ${χ}_{eff}^{( 2 )} ( pm / V )$ | −20.4 | −13.0 |
| n_{g} | 2.2 | 2.21 |
| n₀ | 2.09 | 2.06 |
| r_{AlN} | 85.12 | 91.1 |
| r_{MQW} | 5.84 | —- |
| ${χ}_{AlN}^{( 2 )} ( pm / V ) / {r}_{13} ( pm / V )$ | −14.3/−0.79 | −14.3/−0.79 |
| ${χ}_{MQW}^{( 2 )} ( pm / V ) / {r}_{13} ( pm / V )$ | −139.7/−7.3 | |

The enhancement of the second-order susceptibility and the Pockels EO effect in AlN-based photonic integrated circuit (PIC) devices was investigated by employing AlGaN/AlN MQWs on top of the AlN waveguides on a sapphire substrate. To characterize the EO enhancement, AlN MRMs with and without MQWs were fabricated, and the resonance shift under the applied voltage was measured for each case. The MRMs with MQWs showed the increased resonance shift factors of 2.16 and 1.56 at 1550 nm and 780 nm wavelengths, respectively, compared to AlN MRMs with similar dimensions but without MQWs. This enhancement can be attributed to the high second-order susceptibility of the MQW layers, which are measured to be 20 (at 1550 nm) and 10 (at 780 nm) times higher than bare AlN. This indicates that a further enhancement in the effective Pockels effect is expected by increasing the overlap between the guided mode of the MRM and MQW layer. Also investigated was the effect of fixed charges at the AlN-dielectric cladding interface on the Pockels coefficient using different cladding layers. The MRMs with Al₂O₃ and SiO₂ cladding layers show a similar magnitude of Pockels effect but a different sign. With existing SiN platforms that can provide ultra-low-loss waveguides but lacks Pockels EO effect, a new heterogeneous Al(Ga)N PIC platform with enhanced EO modulation and low optical loss to operate over a wide wavelength range is provided.

Described herein are examples that demonstrate an enhanced Pockels effect by utilizing AlGaN/AlN multiple quantum wells (MQWs) regrown on the AlN layer. This enhancement is attributed to the large built-in polarization field in the MQWs, which results in a higher second-order susceptibility in the MQW layer due to the electric-field induced second-order effect overlapping with the optical mode of the waveguiding device. Separate AlN microring resonator modulators (MRMs) with MQWs operating at two different wavelengths (about 1550 nm and about 780 nm) were investigated. The resonance shift due to the Pockels effect was characterized by applied voltages and compared with the AlN MRM of similar dimensions but without MQWs. Enhanced resonance shift factors of 2.16 (at 1550 nm) and 1.56 (at 780 nm) were achieved for resonators with MQWs compared to those without MQWs. Through a modal overlap analysis between the MQW layers and the optical mode of the resonator, the second-order susceptibility in the MQW regions was extracted and shown to be 20 (at 1550 nm) and 10 times (at 780 nm) higher compared to that of AlN. With the disclosed heterostructures, III-Nitride integrated photonic modulators with a stronger Pockels effect may be realized, e.g., by employing MQWs with optimal overlap with the optical mode of the modulator.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A photonic device comprising:
a substrate; and
a heterostructure supported by the substrate;
wherein the heterostructure comprises:
a base layer comprising an aluminum nitride (AlN)-based material; and
a multiple quantum well or short-period superlattice structure supported by the base layer;
wherein the multiple quantum well or short-period superlattice structure comprises a stack of AlN-based quantum well layers and AlN-based barrier layers.

2. The photonic device of claim 1, wherein:
the AlN-based quantum well layers comprise AlGaN; and
the AlN-based barrier layers comprise AlN.

3. The photonic device of claim 1, wherein:
the heterostructure further comprises a buffer layer disposed between the base layer and the stack of AlN-based quantum well layers and AlN-based barrier layers; and
the buffer layer comprises AlN.

4. The photonic device of claim 1, further comprising an electrode spaced from the heterostructure to apply an electric field to the heterostructure.

5. The photonic device of claim 1, further comprising a waveguide bus disposed alongside the heterostructure for photonic coupling with the heterostructure.

6. The photonic device of claim 1, wherein the heterostructure is a ring-shaped.

7. The photonic device of claim 1, wherein the AlN-based material of the base layer is AlN.

8. The photonic device of claim 1, wherein the AlN-based quantum well layers have an Al composition that falls in a range from about 75% to about 80%.

9. The photonic device of claim 1, wherein the substrate comprises sapphire.

10. A photonic device comprising:
a substrate; and
a heterostructure supported by the substrate;
wherein the heterostructure comprises:
a base layer comprising a III-nitride material having a bandgap greater than about 4 eV; and
a multiple quantum well or short-period superlattice structure supported by the base layer;
wherein the multiple quantum well or short-period superlattice structure comprises a stack of alternating III-nitride quantum well layers and III-nitride barrier layers.

11. The photonic device of claim 10, wherein:
the III-nitride quantum well layers comprise AlGaN; and
the III-nitride barrier layers comprise AlN.

12. The photonic device of claim 10, wherein the III-nitride quantum well layers have an Al composition that falls in a range from about 75% to about 80%.

13. The photonic device of claim 10, wherein the base layer comprises AlN.

14. The photonic device of claim 10, wherein:
the heterostructure further comprises a buffer layer disposed between the base layer and the stack of alternating III-nitride quantum well layers and III-nitride barrier layers; and
the buffer layer comprises AlN.

15. A photonic device comprising:
a substrate; and
a heterostructure supported by the substrate;
wherein the heterostructure comprises:
a base layer comprising a III-nitride material; and
a multiple quantum well or short-period superlattice structure supported by the base layer;
wherein the multiple quantum well or short-period superlattice structure comprises a stack of alternating III-nitride quantum well layers and III-nitride barrier layers; and
wherein the III-nitride material of the base layer and the III-nitride quantum well layers are lattice mismatched.

16. The photonic device of claim 15, wherein:
the III-nitride quantum well layers comprise AlGaN; and
the III-nitride barrier layers comprise AlN.

17. The photonic device of claim 15, wherein the III-nitride quantum well layers have an Al composition that falls in a range from about 75% to about 80%.

18. The photonic device of claim 15, wherein the base layer comprises AlN.

19. The photonic device of claim 15, wherein:
the heterostructure further comprises a buffer layer disposed between the base layer and the stack of alternating III-nitride quantum well layers and III-nitride barrier layers; and
the buffer layer comprises AlN.
